(19) United States
(12) Patent Application Publication
(10) Pub. No.: US 2013/0108974 A1
(43) Pub. Date: May 2, 2013

(54) CARBON BAKING HEAT RECOVERY FIRING SYSTEM

(71) Applicants: Tom HAINES, Evansville, IN (US); Michael E. McGEE, Greenville, SC (US)

(72) Inventors: Tom HAINES, Evansville, IN (US); Michael E. McGEE, Greenville, SC (US)

(73) Assignee: FLUOR TECHNOLOGIES CORPORATION, Aliso Viejo, CA (US)

(21) Appl. No.: 13/282,073

(22) Filed: Oct. 26, 2011

(51) Int. Cl. F27B 13/12; F27D 17/00

(52) U.S. Cl. 432/18; 432/176; 432/29

(57) ABSTRACT

Heat recovery devices and methods for carbon baking furnaces are presented in which at least a portion of the waste heat from the cooling section is recycled through the furnace, which not only reduces the amount of natural gas required, but also increases the oxygen content in the furnace thereby reducing undesirable pitch build-up.

### FIELD OF THE INVENTION

The field of the invention is devices and methods for heat recovery in furnaces, and especially in ring furnaces for carbon baking operations.

### BACKGROUND

Carbon baking furnaces, and particularly ring furnaces, are often used in the manufacture of carbon anodes for the aluminum smelting processes. Due to the high temperatures and long baking times, anode baking requires substantial quantities energy and has become a significant contributor to production cost. Moreover, due to the often relatively low oxygen content in the furnace, pitch is not completely combusted and tends to lead to fires, variations in operating conditions, and maintenance for downstream scrubber systems.

Numerous ring furnaces for carbon baking and methods of operating same are known in the art, and exemplary devices and methods are described, for example, in WO 02/099350, U.S. Pat. Nos. 4,215,982, 4,284,404, and 6,339,729, and W09855426A1. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

While most of these known furnaces are satisfactory for a particular operation, they often tend to limit their use to baking of materials within relatively small dimensional variation. To overcome such disadvantage, GB 948,038 teaches a baking furnace with a refractory floor and vertical metal flues to so adapt to baking of carbonaceous bodies of widely different sizes and shapes under conditions of increased thermal efficiency, increased unit capacity, and reduced furnace construction and operational costs. Among other configurations, the furnace of the '038 reference is configured to allow feeding of the exhaust gas after leaving the furnace back to the combustion source. However, such feedback is typically not suitable for a ring furnace.

In yet another known attempt to improve energy efficiency, EP 0 158 387 teaches heating of carbon materials in a first pre-heating stage up by use of hot combusted volatile matter, which is obtained by withdrawing the released volatile matter from the first stage, burning the volatile matter outside the first stage, and by recycling the burnt volatile matter to the first stage. Such configuration advantageous improves the pre-heating. Nevertheless, considerable amounts of energy are still required for the firing section of the furnace.

Thus, even though numerous configurations and methods for carbon baking furnaces are known in the art, there is still a need for more energy efficient furnaces.

### SUMMARY OF THE INVENTION

The inventive subject matter is drawn to various devices and methods for reduction of loss of heat and energy consumption in a furnace, and most typically in a ring furnace, by heat recovery from heated gases from a cooling zone. Most typically, heat recovery is performed by recycling at least a portion of heated flue gases from the cooling zone back to the firing zone, most preferably together with a fuel stream entering the firing zone. Additional benefits of such configurations will also reduce pitch formation due to the increased oxygen content in the furnace.

In one aspect of the inventive subject matter, a heat recovery system for use in a furnace will include a plurality of wall elements, each having an internal flue channel, wherein the plurality of wall elements are fluidly coupled to each other such that the internal flue channels form a continuous flow path to form, in sequence, a pre-heat zone, a firing zone, and a cooling zone. Contemplated furnaces will also include a firing unit that is coupled to one or more wall elements and that provides a mixture of a fuel (preferably natural gas) and at least a portion of the exhaust gas from the cooling zone to thereby produce a mixed fuel stream. In most cases, the furnace is configured as a ring furnace.

Most preferably, an exhaust duct is provided and receives exhaust gas from multiple wall elements, and the firing unit receives a portion of the exhaust gas from the exhaust duct. In typical embodiments, the firing unit receives the exhaust gas from two or more wall elements from the cooling zone. Alternatively, the firing unit may also receive the exhaust gas from two or more wall elements from the cooling zone. Regardless of the particular configuration, it is generally preferred that the exhaust gas has a temperature of between 1000° C. and 1150° C., and more preferably between 1050° C. and 1100° C.

Consequently, in another aspect of the inventive subject matter, a method for reducing energy consumption of a furnace having a plurality of wall elements, each having an internal flue channel, wherein the plurality of wall elements are fluidly coupled to each other such that the internal flue channels form a continuous flow path to form, in sequence, a pre-heat zone, a firing zone, and a cooling zone, includes a step of coupling a firing unit to at least one wall element, and another step of providing via the firing unit a mixed fuel stream that is formed from a fuel and at least a portion of an exhaust gas from the cooling zone in amount effective to reduce an quantity of fuel as compared to a quantity of fuel used without the exhaust gas.

For example, it is contemplated that the portion of the exhaust gas is fed to the firing unit from an exhaust duct that receives exhaust gas from more than one wall element or that the portion of the exhaust gas is fed to the firing unit from at least two wall elements. Most typically, the exhaust gas has a temperature of between 1000° C. and 1150° C., and more preferably between 1050° C. and 1100° C., and the fuel is natural gas.

Viewed from yet another perspective, the inventor also contemplates a method for reducing energy consumption of a furnace as described above that includes a step of recovering heat from the cooling zone and recycling the recovered heat to the firing zone. In especially preferred aspects of such methods, the heat is recovered by recycling of at least a portion of exhaust gas from the cooling zone to the firing zone. Alternatively, heat may also be recovered via a heat exchanger that uses heat of the exhaust gas from the cooling zone to thereby heat the fuel stream that is fed into the firing zone.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

Prior art FIG. 1 is a schematic of an exemplary ring furnace for baking carbon anodes.

Prior art FIG. 2 is a partial cut-away view of the exemplary ring furnace of FIG. 1.

Prior art FIG. 3A is a schematic illustration of a ring furnace.

FIG. 3B is a schematic illustration of a ring furnace using heat recovery according to the inventive subject matter.

### DETAILED DESCRIPTION

The inventor has now discovered that a carbon baking ring furnace can be equipped with a heat recovery firing system that significantly reduces fuel (e.g., natural gas) consumption by use of heat that is otherwise lost to the atmosphere from cooling of the baked carbon materials. Moreover, use of the heat recovery firing system also increases the oxygen level in the furnace, which leads to more complete combustion of pitch and thereby reduces maintenance costs for downstream scrubber systems and helps avoid fires. In especially preferred aspects, furnace off gas from the cooling section is recovered and recycled to the firing section to assist and/or replace dump burners that dump raw natural gas into the furnace flues. Thus, in at least some preferred aspects, the pre-heated off gas from the cooling section is mixed with natural gas prior to being fed into the furnace flues. Heat recovery firing system for carbon baking furnaces would reduce natural gas consumption 25% to 40%, would be safer, and would reduce maintenance cost of down stream scrubber systems.

In especially preferred aspects of the inventive subject matter, a heat recovery system for use in a furnace comprises a plurality of conduits that allow transfer of at least a portion of exhaust gas from a cooling zone and/or an exhaust collection conduit back to the firing zone. Of course, it should be appreciated that the zones as referred to herein are not positionally fixed zones, but (typically identically configured) zones that are operated as pre-heating, firing, and cooling zones. Moreover, it should be noted that each of the pre-heating, firing, and cooling zones will have a plurality of sections. Thus, in most typical embodiments, each zone and/or section will comprise a plurality of wall elements, each having an internal flue channel, wherein the plurality of wall elements are fluidly coupled to each other such that the internal flue channels form a continuous flow path to form, in sequence, the pre-heat zone, the firing zone, and the cooling zone. A firing unit is then operationally coupled to at least one wall element (of a single section or zone) and configured to provide a mixture of a fuel and at least a portion of the exhaust gas from the cooling zone to thereby produce a mixed fuel stream to the firing zone.

Prior art FIG. 1 schematically illustrates an exemplary ring furnace 100 having two parallel trains of sections (e.g., 1-16) that are fluidly coupled by a crossover to form a ring furnace (it should be noted that the preheat, firing, and cooling zones rotate around the furnace). As the firing zone advances, anodes are removed and added in sections in advance of the firing zone to so allow continuous operation of the furnace runs. In the bake furnace (100) example of Prior Art FIG. 1, there are two firing zones (120) moving in counter clockwise direction with each advance. An advance increments the process one section at a time around the furnace. The firing frame (122, only one labeled), preheat zones (130), cooling zones (110), exhaust manifold (132), and cooling manifold (112) advance around the ring furnace with the firing zones. Stationary parts of the furnace are the crossover (140, only one labeled) and common collection side exhaust main (150, only one labeled) as well as the sections, flues, and walls.) Each train has a pre-heating zone 130 and 130′ with a firing zone 120 and 120′, one or more firing frames 122 (only one is labeled), and cooling zone 130 and 130′, respectively. Crossover 140 connects the trains and exhaust gas from exhaust gas manifolds 132 and 132′ is delivered to common exhaust collection conduit 150. As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Prior art FIG. 2 provides a more detailed schematic view of the sections in the furnace. Here, numeral 1 depicts within the pit that is formed by two adjacent wall elements anodes (in light grey) and packing coke (in dark grey). The wall elements 2 include a conduit within which the combustion gases move from one zone to another via fluid coupling through openings in the headwall 4 of the wall elements. Circulation of the hot gases is schematically indicated with the numeral 5. As is readily apparent from this illustration, multiple wall elements 2 form multiple pits of a single section 3 within a zone and help convey heated gases from one section to another and one zone to another. The sections and flues are typically contained within a concrete tub 6 that is lined with thermal insulation 7. Movement of the draft frame, the firing unit, and the exhaust manifold is typically performed manually. Fire control is performed in either semi automated or fully automated manner using a computer to control the process (not shown).

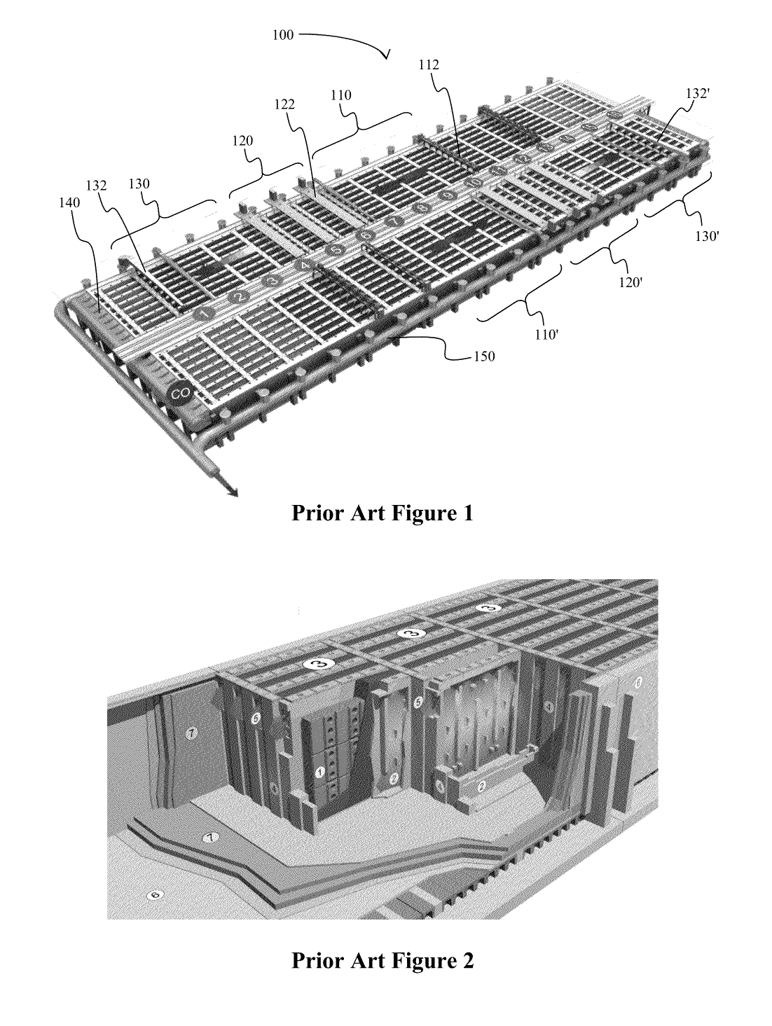

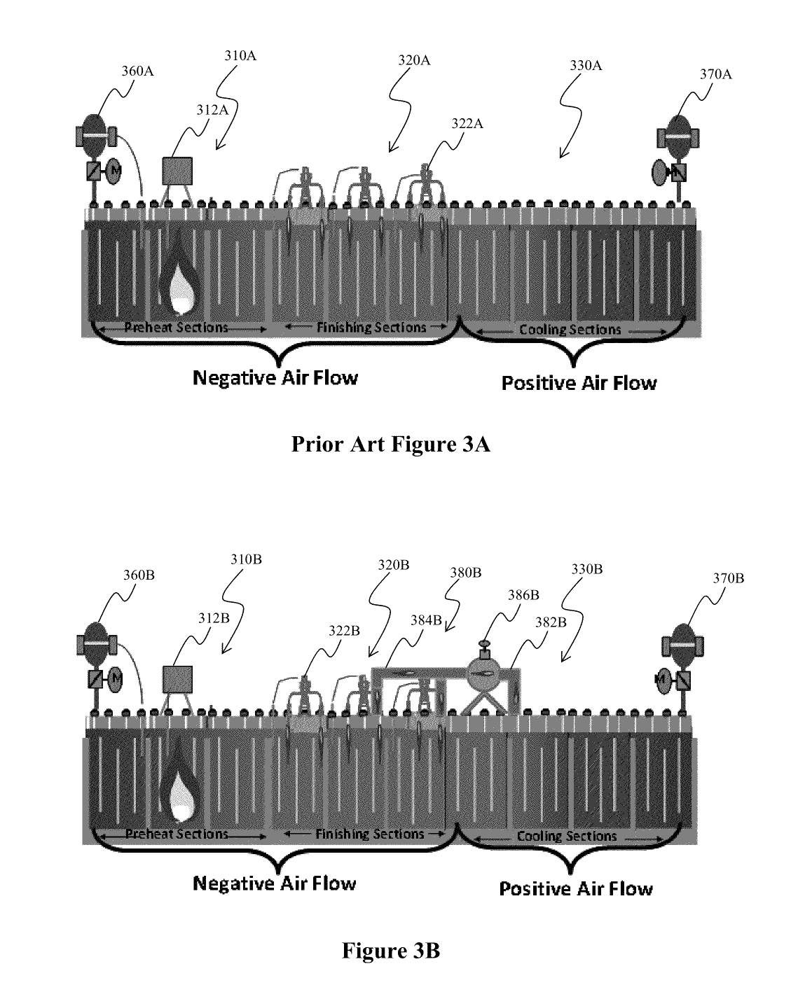

Prior Art FIG. 3A is provided to contrast known ring furnace firing with use of the heat recovery firing system of FIG. 3B according to the inventive subject matter. Here, the preheat zone 310A comprises three distinct sections that are fluidly and thermally coupled to each other. The temperature of these sections (from left to right) is typically 200-600° C., 600-850° C., and 850-1050° C., respectively, while the firing zone 320A includes three sections with temperatures of about 1050-1200° C. in each zone. Downstream of the firing zone is a cooling zone 330A that includes three sections with decreasing temperatures of 1050-1200° C., 1075-1150° C., and 800-900° C., respectively. Gas frames of firing unit 322A provide a flow of natural gas into the wall elements and heat to the process, while draft frame 312A measures negative air flow. Exhaust manifold 360A and cooling manifold 370A are schematically illustrated at the ends of the zones. (The firing zone can be configured to contain multiple sections in both 3A and 3B)

Similarly, the ring furnace of FIG. 3B has a preheat zone 310B that has three distinct sections that are fluidly and thermally coupled to each other. The temperature of these sections (from left to right) is typically 200-600° C., 600-850° C., and 850-1050° C., respectively, while the firing zone 320B includes three sections with temperatures of about 1050-1200° C. in each zone. Downstream of the firing zone is a cooling zone 330B that includes three sections with decreasing temperatures of 1050-1200° C., 1075-1150° C., and 800-900° C., respectively. Gas frames of firing unit 322B provide a flow of natural gas into the wall elements and heat to the process, while draft frame 312B provides air intake. Exhaust manifold 360B and cooling manifold 370B are schematically illustrated at the ends of the zones. The number of sections in the preheat, firing, and cooling zones can vary depending on furnace design and operation.

However, the ring furnace of FIG. 3B also includes a heat recovery firing unit 380B that comprises a conduit 382B that is fluidly coupled to at least one section of the cooling zone and at least one other conduit 384B that provides at least a portion of the exhaust gas from at least one section of the cooling zone back to at least one section of the firing zone. Moreover, it is generally preferred that the heat recovery firing unit 380B also includes a fuel port 386B to so deliver and combine a fuel with the exhaust gas.

Most typically, conduit 382B is fluidly coupled to a section of the cooling zone where the exhaust gas has a temperature of between 1150-1200° C., 1100-1150° C., 1050-1100° C., 1000-1050° C., 950-1000° C., 900-950° C., and/or 800-900° C. Temperatures will vary with the addition or subtraction of sections within the zone. Conduit 382B is typically configured as a multi-flow conduit using a manifold that extends across the width of a section. Additionally, it is contemplated that multiple conduits can be implemented, and that these conduits draw exhaust gas from different sections within the cooling zone. Alternatively, or additionally, conduit 382B may also be fluidly coupled to an exhaust duct that receives exhaust gas from more than one wall element in a section and/or zone. Thus, by choice of the position of the conduit 382B, heat from the cooling zone that would otherwise be lost is recovered and recycled to the firing zone.

Of course, it should be appreciated that the so recovered exhaust gas from the cooling section can be directly combined with fuel to form a fuel gas mixture that is then introduced into the firing zone. Alternatively, the exhaust gas may also be passed through a heat exchanger that heats air or other oxygen-containing gas mixture to a temperature suitable for introduction into the firing zone. Most preferably, but not necessarily, the air or other oxygen-containing gas mixture is combined with a fuel for combustion. While numerous fuels are known in the art, it is generally preferred that the fuel is natural gas.

In still further contemplated aspects of the inventive subject matter, it is preferred that the heat recovery firing unit operates independently but in conjunction with a conventional firing unit and thus supplements heat provided by the conventional firing unit. Alternatively, the heat recovery firing unit may be configured as a combined firing unit that is used in place of a conventional firing unit. Such heat recovery firing units will typically comprise a fuel receiving port and a manifold for receiving exhaust gas from the cooling section(s) and/or a manifold for distributing a mixture of the fuel and the exhaust gas. As already noted before, the fuel mixture is then introduced into one or more sections of the firing zone.

Consequently, a method for reducing energy consumption of a furnace is contemplated where the furnace has a plurality of wall elements with an internal flue channel, wherein the wall elements are fluidly coupled to each other such that the internal flue channels form a continuous flow path to form, in sequence, a pre-heat zone, a firing zone, and a cooling zone. In such a method, it is generally preferred that a heat recovery firing unit is coupled to at least one wall element, and that a mixed fuel stream that is formed from a fuel and at least a portion of an exhaust gas from the cooling zone is provided to at least one section of a firing zone in amount effective to reduce an quantity of fuel as compared to a quantity of fuel used without the exhaust gas. In especially preferred methods, and based on various computations by the applicant, it is noted that the same operational parameters can be achieved using contemplated systems and methods with between 5-10%, more typically between 10-25%, and most typically 25-40% less fuel than compared to a system without heat recovery firing unit. Consequently, it should be appreciated that recovering of heat from the cooling zone and recycling the recovered heat to the firing zone can lead to substantial fuel savings.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A heat recovery system for use in a furnace, comprising:
a plurality of wall elements, each having an internal flue channel, wherein the plurality of wall elements are fluidly coupled to each other such that the internal flue channels form a continuous flow path to form, in sequence, a pre-heat zone, a firing zone, and a cooling zone; and
a firing unit operationally coupled to at least one wall element and configured to provide a mixture of a fuel and at least a portion of an exhaust gas from the cooling zone to thereby produce a mixed fuel stream.

2. The heat recovery system of claim 1 further comprising an exhaust duct that is configured to receive the exhaust gas from more than one wall element, wherein the firing unit is configured to receive the portion of the exhaust gas from the exhaust duct.

3. The heat recovery system of claim 2 wherein the firing unit is further configured to receive the portion of the exhaust gas from at least two wall elements from the cooling zone.

4. The heat recovery system of claim 1 wherein the firing unit is further configured to receive the portion of the exhaust gas from at least two wall elements from the cooling zone.

5. The heat recovery system of claim 1 wherein the firing unit is further configured to receive the portion of the exhaust gas at a temperature of between 1000° C. and 1150° C.

6. The heat recovery system of claim 1 wherein the firing unit is further configured to use natural gas as the fuel.

7. The heat recovery system of claim 1 wherein the furnace is configured as a ring furnace.

8. A method for reducing energy consumption of a furnace having a plurality of wall elements, each having an internal flue channel, wherein the plurality of wall elements are fluidly coupled to each other such that the internal flue channels form a continuous flow path to form, in sequence, a pre-heat zone, a firing zone, and a cooling zone, comprising:
operationally coupling a firing unit to at least one wall element; and
providing via the firing unit a mixed fuel stream that is formed from a fuel and at least a portion of an exhaust gas from the cooling zone in amount effective to reduce an quantity of fuel as compared to a quantity of fuel used without the exhaust gas.

9. The method of claim 8 wherein the portion of the exhaust gas is fed to the firing unit from an exhaust duct that receives exhaust gas from more than one wall element.

10. The method of claim 8 wherein the portion of the exhaust gas is fed to the firing unit from at least two wall elements.

12. The method of claim 8 wherein the portion of the exhaust gas has a temperature of between 1000° C. and 1150° C.

13. The method of claim 8 wherein the fuel of the firing unit is natural gas.

14. The method of claim 8 wherein the furnace is a ring furnace.

15. A method for reducing energy consumption of a furnace having a plurality of wall elements, each having an internal flue channel, wherein the plurality of wall elements are fluidly coupled to each other such that the internal flue channels form a continuous flow path to form, in sequence, a pre-heat zone, a firing zone, and a cooling zone, comprising a step of recovering heat from the cooling zone and recycling the recovered heat to the firing zone.

16. The method of claim 15 wherein the heat is recovered by recycling of at least a portion of exhaust gas from the cooling zone to the firing zone.

17. The method of claim 16 wherein the portion of the exhaust gas is combined with a fuel prior to feeding into the firing zone.

18. The method of claim 15 wherein the heat is recovered via a heat exchanger that uses heat of an exhaust gas from the cooling zone to heat a fuel stream that is fed into the firing zone.
